(19) United States
(12) Patent Application Publication
(10) Pub. No.: US 2005/0263393 A1
(43) Pub. Date: Dec. 1, 2005

(54) System and method of performing electrochemical tests of solid oxide fuel cells

(75) Inventor: Eduardo E. Paz, Collegeville, PA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Franklin Fuel Cells, Inc., Malvern, PA (US)

(21) Appl. No.: 11/117,729

(22) Filed: Apr. 29, 2005

Related U.S. Application Data
(60) Provisional application No. 60/566,446, filed on Apr. 30, 2004.

(51) Int. Cl. G01N 27/26; H01M 8/00

(52) U.S. Cl. 204/400; 429/13; 205/775

(57) ABSTRACT

A system for and method of electrochemical testing of fuel cells, such as solid membrane fuel cells, is presented. The system and method allow for non-destructive testing of one or more solid membrane fuel cells. In particular, the system and method allow for testing a working first fuel cell in a testing fixture. The first fuel cell may be removed from the testing fixture without substantial damage to the first fuel cell and replaced by a second fuel cell. The second fuel cell may be electrochemically tested, removed without substantially damaging it, and the process repeated with additional fuel cells.

### RELATED APPLICATIONS

The present application claims priority to U.S. Provisional Application Ser. No. 60/566,446 entitled “Apparatus for Performing Electrochemical Tests of Solid Oxide Fuel Cells” to Paz, which is expressly incorporated by reference herein in its entirety.

### FIELD OF THE INVENTION

The present invention relates to an apparatus and method for electrochemical testing of solid oxide fuel cells. The apparatus and method allow for non-destructive testing of individual or multiple solid oxide fuel cells. More particularly, the apparatus and method allow for electrochemical testing of one or more fuel cells without having to contain the fuel cells in a permanently-sealed housing. The apparatus and method may be used for, by way of non-limiting example, prototyping or quality control in manufacturing.

### DESCRIPTION OF RELATED ART

Solid oxide fuel cells have grown in recognition as a viable high-temperature fuel cell technology. There is no liquid electrolyte, thereby eliminating metal corrosion and electrolyte management problems typically associated with the use of liquid electrolytes. Rather, the electrolyte of the cells is made primarily from solid ceramic materials that are capable of surviving the high temperature environment typically encountered during operation of solid oxide fuel cells. The operating temperature of greater than about 600° C. allows internal reforming, promotes rapid kinetics with non-precious materials, and produces high quality by-product heat for cogeneration or for use in a bottoming cycle.

There is currently much research regarding solid oxide fuel cells. Typically, such cells must be stacked and/or sealed in order to undergo electrochemical testing. Electrochemical testing of individual solid oxide fuel cells typically destroys the fuel cells, or renders them essentially useless. In addition, it is time consuming and tedious to have to stack and/or seal the cells during prototype evaluation. It would be beneficial to develop an apparatus and method capable of non-destructive testing of a solid oxide fuel cell. More generally, it would be beneficial to develop an apparatus and method capable of non-destructive testing of a solid membrane fuel cell, regardless of type.

The description herein of advantages and disadvantages of various features, embodiments, methods, and apparatus disclosed herein is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

It would be desirable to provide an apparatus and method capable of testing a single solid oxide fuel cell or multiple solid oxide fuel cells that does not render the fuel cell or cells useless. A feature of an embodiment of the invention is therefore to provide an apparatus for and method of electrochemical testing of single solid oxide fuel cells or multiple solid oxide fuel cells that allows fast and easy replacement of the fuel cell or cells in the test apparatus, and that does not destroy the apparatus or the fuel cell or cells. More generally, the apparatus and method may be used to efficiently test solid membrane fuel cells regardless of type.

Furthermore, it is useful to be able to test fuel cells early in the development phase, before they have been put in stacks and/or “packaged” (i.e., completed with glass or ceramic seals, etc.) so that the fuel cells that are under development can be tested directly and promptly. The apparatus and method allow for testing fuel cells without requiring the installation of permanent or semi-permanent seals. Such seals are generally constructed of glass or other material such that destruction of the housing, the fuel cells, or both is typically required for disassembly.

The apparatus and method may be used during the prototype phase of fuel cell development. Alternately, or in addition, the apparatus and method may be used during commercial manufacturing of fuel cells for quality control purposes.

According to an embodiment of the present invention, an apparatus for repeated electrochemical testing of a plurality of fuel cells is presented. The apparatus includes a housing configured to contain a first fuel cell during operation of the first fuel cell. The housing includes at least a first electrically conductive member configured to electrically contact an anode of a fuel cell being tested and a second electrically conductive member configured to electrically contact a cathode of a fuel cell being tested. The housing is configured to substantially seal the first fuel cell during testing. The housing is configured to allow removal of the first fuel cell without substantial damage to the first fuel cell and subsequently contain a second fuel cell during operation of the second fuel cell.

Various optional features of the above embodiment include the following. The first fuel cell may be a solid oxide fuel cell, a proton exchange fuel cell, or a direct methanol fuel cell. The first fuel cell may be one of a plurality of electrically connected fuel cells. The housing may include titanium or steel. The apparatus may include a seal constructed of ceramic, ceramic paper, silica, ceramic paste, glass ceramic, mica, glass, or putty. The apparatus may include at least one pressure gauge configured to measure any, or a combination, of a pressure in a fuel line, a pressure in an oxidant line, and a difference in pressure between a fuel line and an oxidant line. The apparatus may be configured to test a fuel reforming catalyst. The housing may include a ceramic. The first fuel cell may be square, rectangular, circular, or an ellipse. The apparatus may include a source of heat. The apparatus may include a first plate and second plate, the first plate and the second plate containing the first fuel cell therebetween, and at least two bolts configured to apply a compressive force to the first fuel cell. The apparatus may include no seal present between the anode and the cathode. The housing configured to substantially seal the first fuel cell during testing may include the housing being configured to substantially prevent oxidant from contacting an anode and fuel from contacting a cathode.

According to an embodiment of the present invention, a method of electrochemically testing a plurality of fuel cells is presented. The method includes containing a first fuel cell in a housing configured to allow for operation of the first fuel cell. The method also includes substantially sealing the first fuel cell. The method further includes operating the first fuel cell. The method further includes measuring at least one parameter of the first fuel cell during the step of operating the first fuel cell. The method further includes removing the first fuel cell from the housing, such that the first fuel cell is substantially undamaged by the step of removing. The method further includes containing a second fuel cell in the housing, such that the second fuel cell is substantially sealed. The method further includes operating the second fuel cell. The method further includes measuring at least one parameter of the second fuel cell during the step of operating the second fuel cell.

Various optional features of the above embodiment include the following. The first fuel cell may be a solid oxide fuel cell, a proton exchange fuel cell, or a direct methanol fuel cell. The first fuel cell may be one of a plurality of connected fuel cells. The method may include measuring at least one parameter relating to a fuel reforming catalyst associated with the first fuel cell. The method may include sealing the fuel cell using ceramic, ceramic paper, silica, ceramic paste, glass ceramic, mica, glass, or putty. The method may include measuring any, or a combination, of a pressure in a fuel line, a pressure in an oxidant line, and a difference in pressure between a fuel line and an oxidant line. The method may include heating the first fuel cell. The may include applying a compressive force to the first fuel cell. The compressive force may be supplied by a weight. The step of removing may not require removing a seal from between an anode and a cathode. The step of substantially sealing may include substantially preventing oxidant from contacting an anode and fuel from contacting a cathode.

According to an embodiment of the present invention, an apparatus for repeated electrochemical testing of a plurality of fuel cells is presented. The apparatus includes means for electrically connecting with a first electrode of a fuel cell. The apparatus also includes means for electrically connecting with a second electrode of a fuel cell. The apparatus further includes means for providing an oxidant to an anode of a fuel cell. The apparatus further includes means for providing fuel to an anode of a fuel cell. The apparatus further includes means for keeping the fuel and oxidant separate. The means for electrically connecting with a first electrode, the means for electrically connecting with a second electrode, the means for providing an oxidant, and the means for providing fuel are configured to allow operation of a first fuel cell, removal of the first fuel cell without substantial damage to the first fuel cell, and subsequent operation of a second fuel cell.

Various optional features of the above embodiment include the following. The apparatus may include means for heating a fuel cell. The apparatus may include means for applying pressure to a fuel cell. The apparatus may include means for substantially sealing a fuel cell.

### BRIEF DESCRIPTION OF THE DRAWINGS

The novel features that are considered characteristic of the invention are set forth with particularity in the appended claims. The invention itself, however, both as to its structure and operation together with the additional objects and advantages thereof are best understood through the following description of exemplary embodiments of the present invention when read in conjunction with the accompanying drawings.

FIG. 1 is a schematic diagram of a fuel cell according to an embodiment of the present invention.

FIG. 2A is a schematic diagram of a cross-section of a testing apparatus according to an embodiment of the present invention.

FIG. 2B depicts two external views of the testing apparatus of FIG. 2A.

FIG. 3 depicts transparent and cross-section views of a testing apparatus according to an embodiment of the present invention.

FIG. 4 is a diagram of an upper brace according to an embodiment of the present invention.

FIG. 5 is a diagram of a lower brace according to an embodiment of the present invention.

FIG. 6 depicts a view of an anode end plate according to an embodiment of the present invention.

FIG. 7 depicts a view of a cathode end plate according to an embodiment of the present invention.

FIGS. 8 depicts a cell frame according to an embodiment of the present invention.

FIG. 9 depicts an outer seal gasket according to an embodiment of the present invention.

FIG. 10 depicts an anode current collector in place on an anode plate according to an embodiment of the present invention.

FIG. 11 depicts an anode fuel plenum according to an embodiment of the present invention.

FIG. 12 is a graph depicting fuel temperature and residence time versus flow rate for one embodiment of the present invention.

FIG. 13 is a schematic diagram of a multi-cell testing apparatus according to an embodiment of the present invention.

FIG. 14 is a schematic diagram of a fuel cell test apparatus according to an embodiment of the present invention.

FIG. 15 depicts a view of a cell holder plate with attached anode plate according to an embodiment of the present invention.

FIG. 16 is a schematic diagram of various fluid flows through an embodiment of the present invention.

FIG. 17 depicts a bottom view and side view of an anode plate according to an embodiment of the present invention.

FIG. 18 depicts a plan view and side view of a cathode plate according to an embodiment of the present invention.

FIG. 19 depicts a detail of top faces of anode and cathode plates according to an embodiment of the present invention.

FIG. 20 is a depiction of installed current leads according to an embodiment of the present invention.

### DETAILED DESCRIPTION OF THE PREFERRED EMBODIMENTS

The terminology used herein is for the purpose of describing particular embodiments only, and is not intended to limit the scope of the present invention. As used throughout this disclosure, the singular forms “a,” “an,” and “the” include plural reference unless the context clearly dictates otherwise. Thus, for example, a reference to “a solid oxide fuel cell” includes a plurality of such fuel cells in a stack, as well as a single cell, a reference to “an anode” is a reference to one or more anodes and equivalents thereof known to those skilled in the art, and so forth.

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods, devices, and materials are now described. All publications mentioned herein are cited for the purpose of describing and disclosing the various anodes, electrolytes, cathodes, and other fuel cell components that are reported in the publications and that might be used in connection with the invention. Nothing herein is to be construed as an admission that the invention is not entitled to antedate such disclosures by virtue of prior invention.

Generally, a solid oxide fuel cell (“SOFC”) includes an air electrode (cathode), a fuel electrode (anode), and a solid oxide electrolyte provided between these two electrodes. In a SOFC, the electrolyte is in solid form. Typically, the electrolyte is made of a nonmetallic ceramic, such as dense yttria-stabilized zirconia (YSZ) ceramic, that is a nonconductor of electrons, which ensures that the electrons must pass through the external circuit to do useful work. As such, the electrolyte provides a voltage buildup on opposite sides of the electrolyte, while isolating the fuel and oxidant gases from one another. The anode and cathode are generally porous, with the cathode oftentimes being made of doped lanthanum manganite. In the solid oxide fuel cell, hydrogen or a hydrocarbon is commonly used as the fuel and oxygen or air is used as the oxidant.

The power generating component of a fuel cell system is commonly called a “stack”. This stack comprises (a) one or more membrane electrode assemblies (“MEA”), the key transactional center of the fuel cell device where chemical energy is converted into electricity; (b) fluid passages for distributing fuel and oxidant, (c) current collectors for conducting current to and from the MEA; and optionally (d) structural hardware for providing any necessary compression for seals and or electrical contacts. Each MEA includes an anode, a cathode, and an electrolyte disposed between the anode and the cathode. A stack allows for a number of MEAs to be electrically connected in serial or parallel combinations in order to affect the total voltage or current of the power generator.

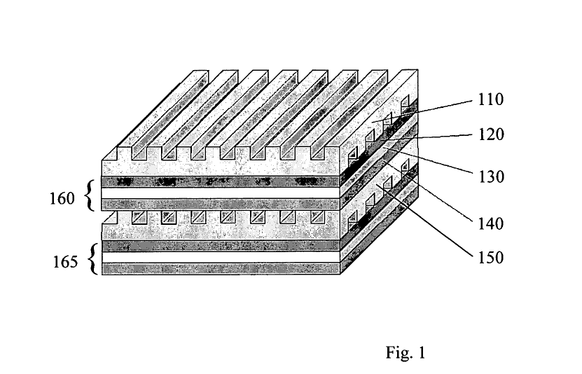

FIG. 1 is a schematic diagram of a fuel cell. Anode 120 is separated from cathode 140 by electrolyte 130. Collectively, anode 120, cathode 140, and electrolyte 120 form MEA 160. Interconnect plate 150 separates MEA 160 from MEA 165. Interconnect plate 110 allows for further fuel cells to be stacked on top of MEA 160.

Although it is the ultimate goal of most fuel cell developers to create highly efficient and productive stacks, a great deal of development work must precede, or take place separately, in order to develop and test the MEAs or other components that will eventually be installed in a finished stack. These tests are typically performed on a special cell testing apparatus. Certain embodiments of this invention pertain to the design and operation of a solid oxide fuel cell electrochemical testing apparatus. More generally, certain embodiments of the present invention pertain to the design and operation of a fuel cell electrochemical testing apparatus without regard to the type of solid membrane fuel cell being tested.

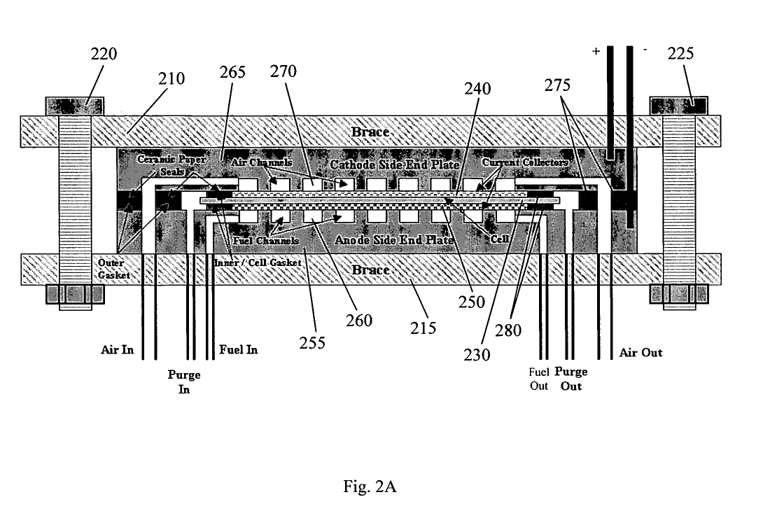

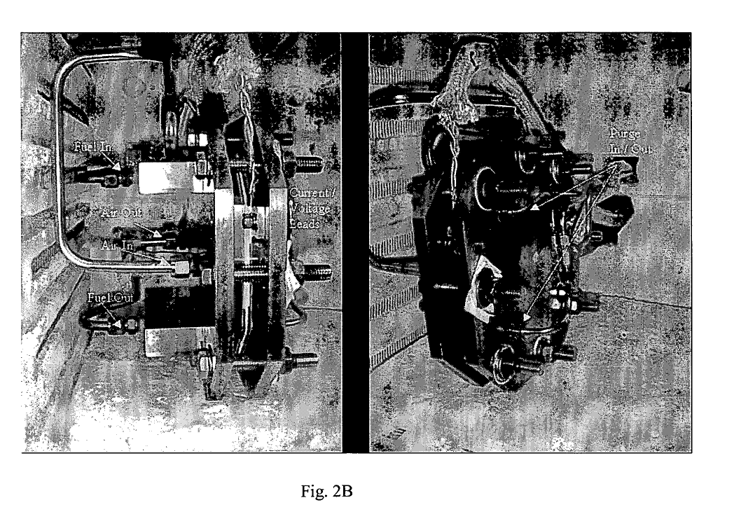

FIG. 2A is a schematic diagram of a cross-section of a testing apparatus according to an embodiment of the present invention. Two braces 210 and 215 are connected together using compression bolts 220, 225. Braces 210 and 215 at least partially contain MEA 230. Anode current collector 250 and cathode current collector 240 abut their respective electrodes. On the anode side, anode end plate 255 includes fuel channels 260 used to supply fuel to the anode. On the cathode side, cathode end plate 265 includes oxidant channels 270. Outer gasket 275 separates anode end plate 255 from cathode end plate 265. Inner gasket 280 prevents fuel and oxidant leakage. FIG. 2B depicts two external views of the testing apparatus of FIG. 2A.

The testing apparatus of FIGS. 2A and 2B is preferably designed to perform electrochemical characterization of a single direct oxidation solid oxide fuel cell. However, this apparatus can be used for a number of other uses, including the following:
1. Electrochemical testing of proton exchange membrane fuel cells (“PEMFC”), direct methanol fuel cells (“DMFC”), and conventional SOFC single cells;
2. Electrochemical testing of multiple cells of any of the above types of fuel cells, with the addition of one or more interconnect plates;
3. Characterization of fuel reforming catalyst performance; and
4. Characterization of fuels, operating temperatures, flow rates, etc.

The testing apparatus of FIGS. 2A and 2B allows fast and easy replacement of the MEA being tested. It is intended to be heated to the test temperature, by way of non-limiting example, by placement inside of a furnace.

Additionally, differential pressure gauges may be used to measure any difference in pressure between the fuel and oxidant flow circuits. Since a higher volumetric flow rate is typically used in the oxidant circuit, that flow circuit is naturally at a higher pressure and some means of applying a backpressure to the fuel side is generally employed to equalize pressure at the different flow rates of the anode and cathode. By equalizing the pressures of the anode and cathode cavities, the tendency to leak oxidant into the fuel circuit, or vice versa, is further reduced.

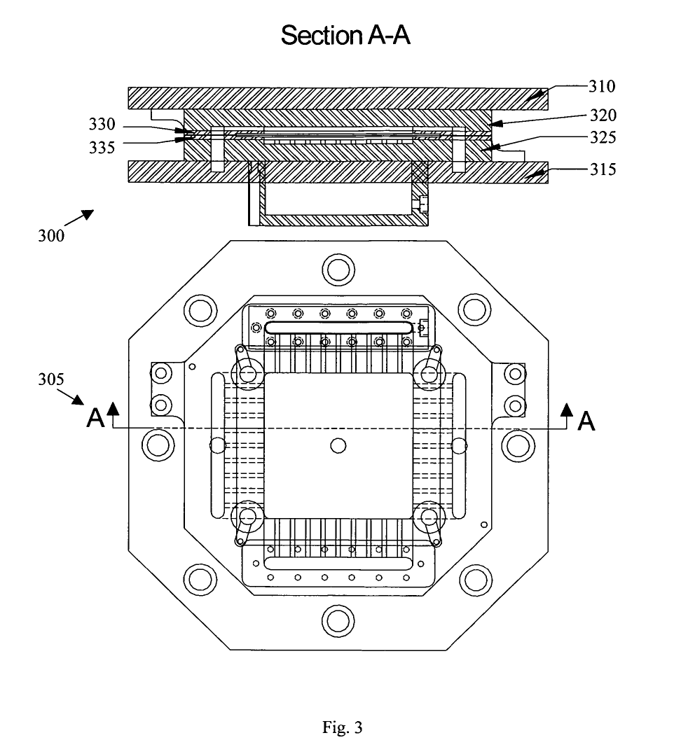

FIG. 3 is a transparent and cross-section view of a testing apparatus according to an embodiment of the present invention. Cross section 300 is taken along line A-A 305. Braces 310, 315 abut electrode end plates 320, 325. The MEA is contained within cell frames 330, 335.

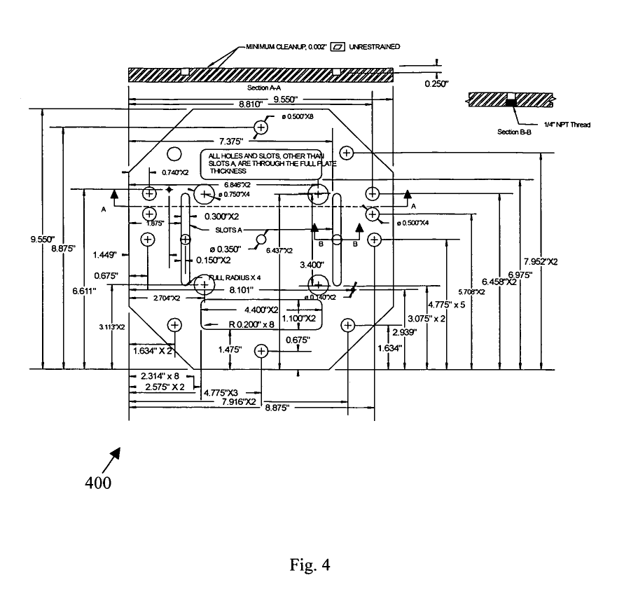

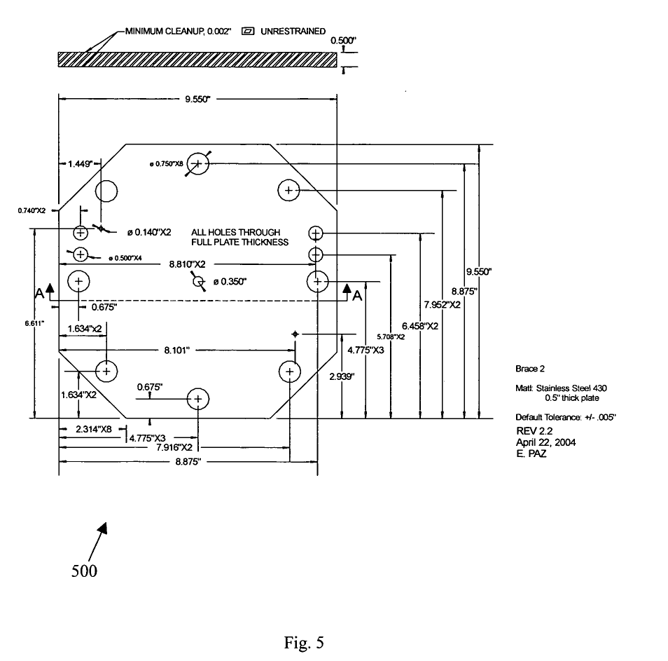

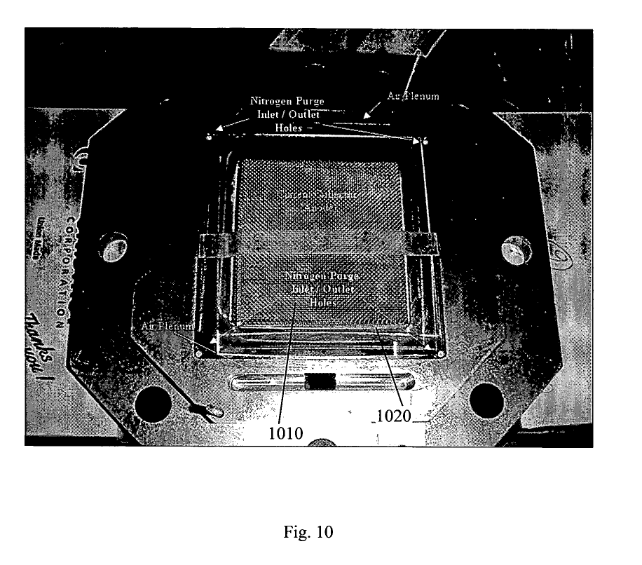

FIGS. 4 and 5 are views of lower brace 400 and upper brace 500, respectively, according to embodiments of the present invention. A testing apparatus according to an embodiment of the present invention preferably includes two such outer braces (e.g., stainless steel) that can be used to transfer a compressive force to the interior plates in order to ensure adequate sealing, reduce electrical contact resistances and hold components in place. By way of non-limiting example, enough compression preferably is applied as to squeeze the ceramic paper outer seals from an uncompressed thickness of about 0.375″ to a final thickness of about 0.075″. The compressive force can be applied by tightening the outer braces toward one another, for example by tightening eight 0.5″ diameter stainless steel bolts. Other mechanisms can be used to effect tightening of the outer braces, as will be appreciated by those skilled in the art. Preferably, the brace material has minimal creep at operating temperatures (e.g., greater than 600° C.). (“Creep” is said to occur when, at high temperatures, a material's strain increases without a corresponding increase in stress.) These outer braces may also be used to house cartridge heaters to enable the testing apparatus to “self” heat from room temperature to test temperatures of 600° C. or higher (see, e.g., FIG. 10). Ceramic insulation could be positioned around the testing apparatus to minimize the required heat input as well as to protect adjacent equipment and enhance operator safety.

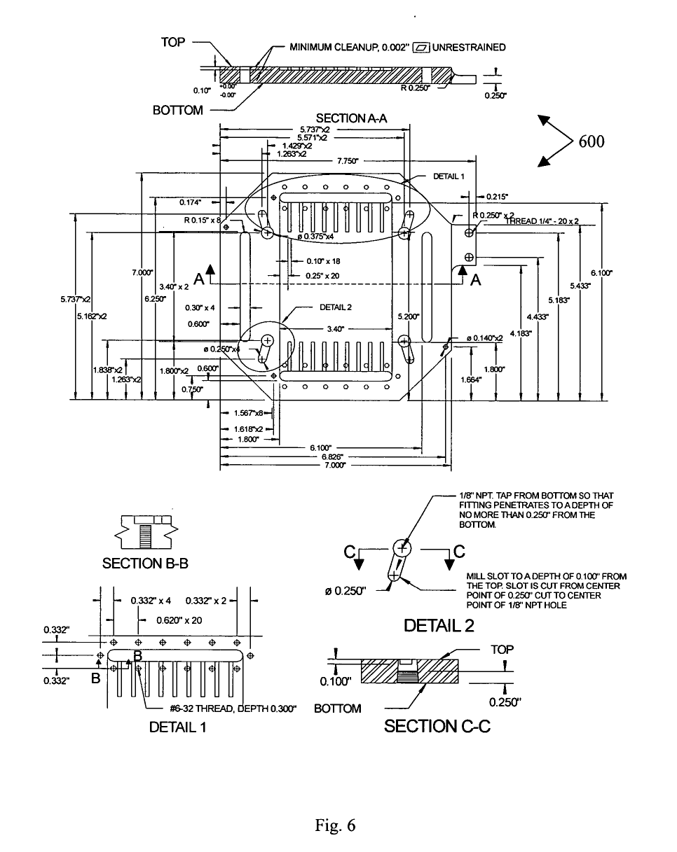

FIG. 6 is a view of an anode end plate according to an embodiment of the present invention. Anode end plate 600 provides connections for fuel inlet and outlet, air inlet and outlet and nitrogen purge inlet and outlet. End plate 600 is preferably made from grade 2 titanium, although any suitable material capable of withstanding the testing conditions of the testing apparatus could be used. Unlike materials used for permanent interconnects, the components of the anode end plate are not preferably constructed of a material that has minimal expansion and contraction due to temperature changes. Also preferable is that construction materials do not react with any fuel or oxidant that they contact. Grade 2 titanium resists carbon formation in the presence of dry hydrocarbons, and, therefore is a preferable material for use in a direct oxidation SOFC. If the cell is to be tested with hydrogen fuel exclusively, then a preferable material choice would be a ferritic steel or series 400 stainless steel. The anode end plate distributes the fuel over the anode side of the cell, collects and conducts electric current, and provides the nitrogen purge around the perimeter of the cell, just outside of the inner cell gasket. Those skilled in the art will be capable of selecting a suitable material for the anode end plate, using the guidelines provided herein.

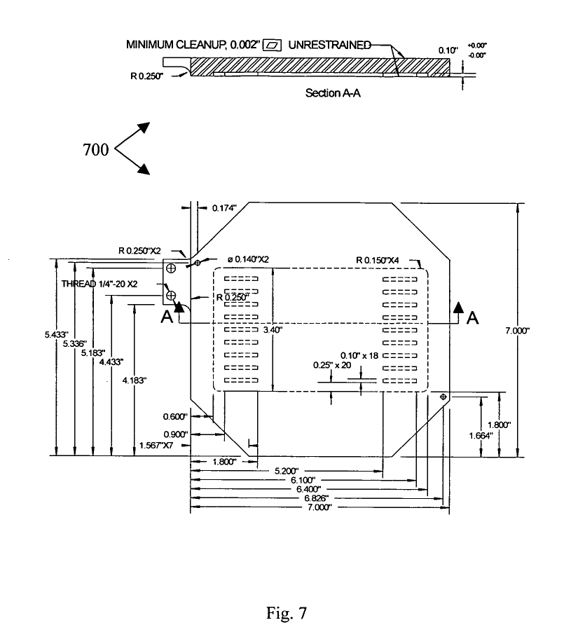

FIG. 7 is a view of a cathode end plate 700 according to an embodiment of the present invention. Cathode end plate 700 distributes oxidant flow over the cell's cathode and collects and conducts electric current. The cathode end plate can be made from the same or different material as the anode end plate (e.g., 600). Preferably, the cathode end plate material does not oxidize or creep at operating temperatures of the test apparatus. With titanium, one also avoids the issue of chromia poisoning of the cathode, which can affect cells tested in materials that form chromia scales when exposed to high temperatures.

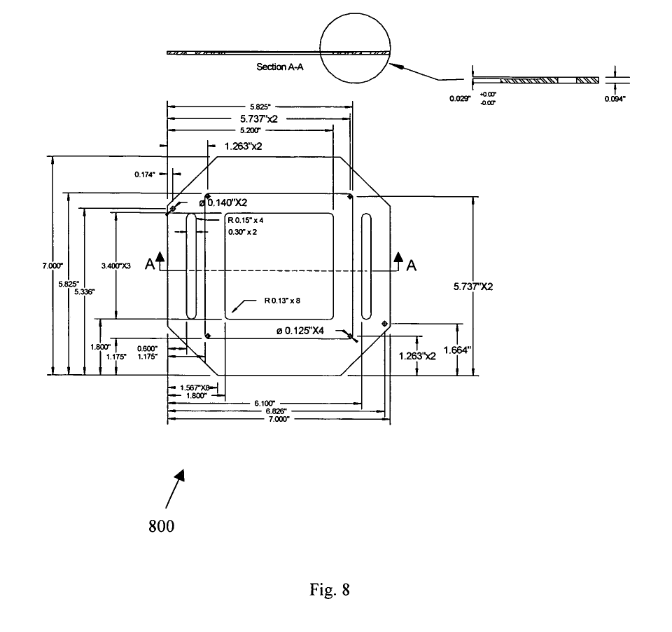

FIG. 8 is a view of a cell frame according to an embodiment of the present invention. Each end plate (e.g., 310, 315 of FIG. 3) includes at least a portion of a fluid manifold. These manifolds are the passages by which fluid (e.g., fuel or oxidant) is transported across the respective cell electrode face. Cell frame 800 serves to seal the passages in the manifold as well as separate the anode and cathode sides of the apparatus from one another. In one embodiment, a portion of each manifold is created by use of a cell frame. In general, cell frames are constructed of the same material as the end plates. Such material is preferably mechanically stable at high temperatures and not reactive with fuel or oxidant. By way of non-limiting example, titanium may be used. In alternate embodiments of the present invention, multiple parts may be machined to include a manifold structure.

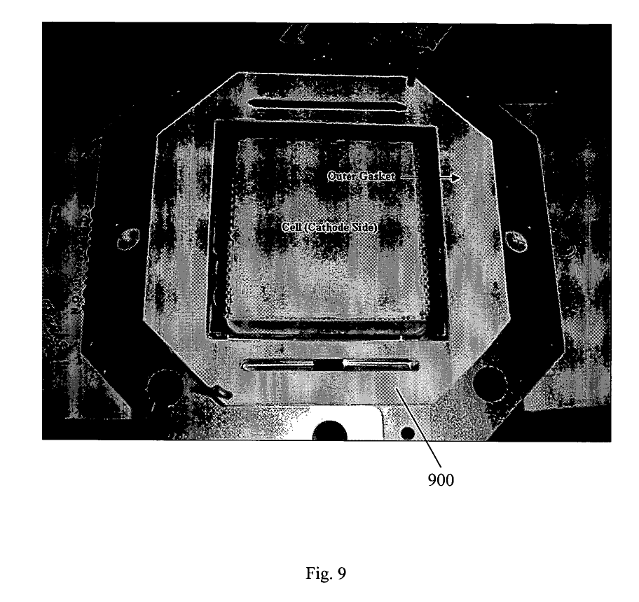

FIG. 9 is a view of an outer seal gasket 900 according to an embodiment of the present invention. Gasket 900 serves to seal the fuel manifold from the oxygen manifold, assuring no leakage from the anode to the cathode sides of the electrolyte. Any insulating material capable of withstanding the testing conditions and forming a suitable seal can be used, and preferred materials include ceramics, ceramic paper, silica, ceramic pastes, mica, glass, putty, and the like. Preferably, the seal is made from commercially available ceramic paper material, Cotronics cat. No. 300-080-3, available from Cotronics Corporation, New York. This sealing material can be cut, e.g., with an X-ACTO knife, into the shape of a gasket and sandwiched between the anode and cathode sides of the fixture to seal and electrically insulate between the two halves of the fixture. To further improve sealing effectiveness, a nitrogen purge fluid network around the edge of the cell flushes away any fuel or oxidant that may leak past the seals (e.g., ceramic paper gaskets).

FIG. 10 is a diagram depicting the anode current collector 1010 in place on anode plate 1020. The testing apparatus can accommodate a number of different types of flowfields (i.e., components that direct the fluid flow over the electrodes) and current collectors, which can be attached to each of the end plates. The preferred embodiment utilizes a flexible pad 3.400″ by 3.100″ by 0.250″ wrapped with a #24 copper, silver or gold mesh for anode current collector 1010. This combination flowfield and current collector 1010 has been designed to be flexible enough to compensate for some camber in the MEA and maintain even contact while providing channels having low flow resistance. Pressure drops equivalent to less than two inches of water across the cell's inlets to outlets at the operating flow rates of the fuel and/or oxidant are desirable.

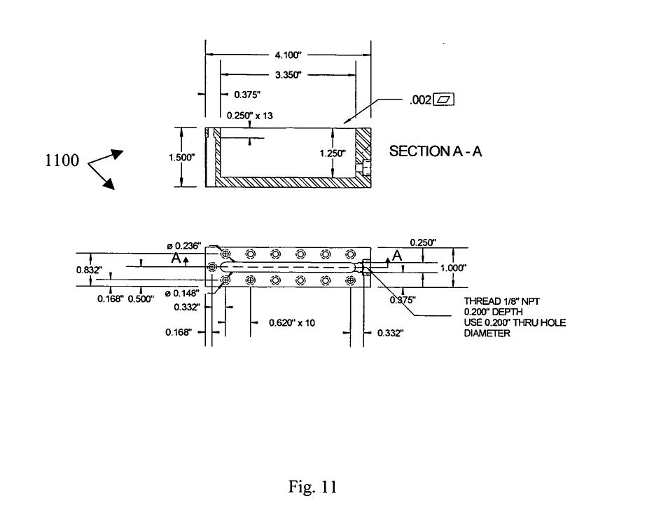

FIG. 11 depicts an anode fuel plenum according to an embodiment of the present invention. Two such plenums 1100 are typically used: one on the fuel inlet side and another on the outlet side. Plenums 1100 provide more uniform inlet and outlet pressures across the full width of the cell. On the anode side, it is preferable to minimize the amount of fuel and flow rates so that fuel efficiency is maximized. In certain embodiments of the present invention, plenums are used only on the anode side. In general, the cathode side of the fuel cell is has a significant excess concentration (i.e., above the stoichiometric amount required for completion of the reaction) and a relatively high flow rate, therefore obviating the need for plenums.

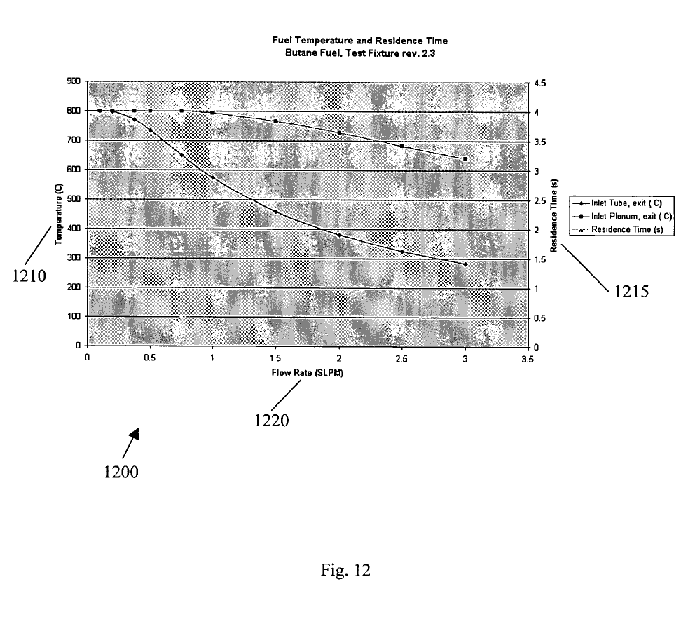

FIG. 12 is a graph 1200 depicting fuel temperatures 1210 (inlet and outlet) and residence time 1215 versus flow rate 1220 for the embodiment of FIGS. 3-10. In general, the fuel inlet tubing and plenums for a preferred testing apparatus should be designed such that hydrocarbon fuel pyrolysis is avoided. This phenomenon occurs when a hydrocarbon fuel is heated to temperatures above 700° C. and allowed to remain at this temperature for residence times exceeding several seconds. To enable the use of a variety of dry hydrocarbon fuels directly in the fuel cell, the fuel passages of the preferred testing apparatus are designed to limit residence time 1215. FIG. 12 may accordingly be used to determine preferable fuel temperature 1210 and flow rate 1220 for the embodiment of FIGS. 3-10. Those of ordinary skill in the art may develop similar graphs for different embodiments of the invention using the teachings contained herein.

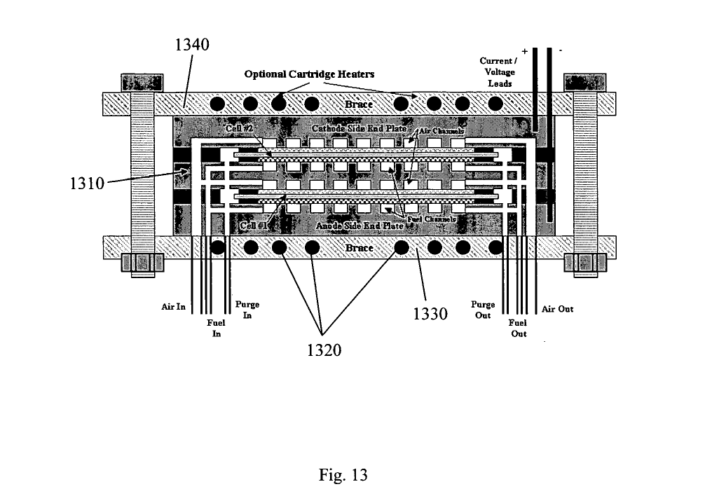

In an embodiment of the present invention, more than one cell may be tested simultaneously. Such an embodiment allows for performance testing in a environment that closely resembles that of a completed stack. FIG. 13 is a schematic diagram of a multi-cell testing apparatus. To test more than one cell in the testing apparatus, an additional interconnect plate 1310 is preferably used. Interconnect plate 1310 allows fuel and oxidant to pass through in separate plenum channels, while separating the cathode cavity of one cell from the anode cavity of the adjacent cell, as shown in FIG. 13. Again, interconnect plate 1310 can be made from the same or different material than the anode or cathode side end plates. In alternate embodiments, the testing apparatus may be designed to accommodate multiple interconnect plates.

FIG. 13 also depicts cartridge heaters 1320 embedded in braces 1330, 1340. Such heaters allow the testing apparatus to heat to test temperatures of, by way of non-limiting example, 600° C. or higher.

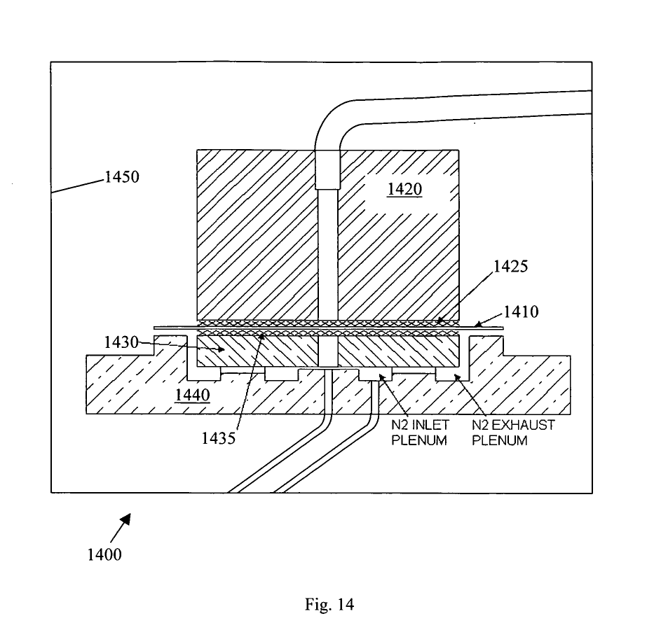

FIG. 14 is a schematic diagram of yet another embodiment 1400 of the present invention. In this embodiment, MEA cell 1410 is sandwiched between anode current collector 1435 and cathode current collector 1425. Anode current collector 1435 abuts anode plate 1430, and cathode current collector 1425 abuts cathode plate 1420. The weight of cathode plate 1420 provides a compressive force against cell 1410 and current collectors 1425, 1435, thereby ensuring that current collectors 1425, 1435 register with their respective electrodes. This close registration of current collectors 1425, 1435 with their electrodes reduces electrical resistance. The compressive force exerted by cathode plate 1420 also serves to isolate the anode and cathode sides of the fuel cell from each-other without requiring seals. Thus, the compressive force prevents fuel from leaking to the cathode side of the fuel cell and oxidant from leaking to the anode side of the fuel cell without the need for end plates or seals. Cell holder 1440 supports the entire structure, assists in directing fluid flow, and seals the cathode side of the cell from the anode side. The embodiment of FIG. 14 is contained within furnace 1450, which provides heat sufficient to maintain an operating temperature for MEA cell 1410. In alternate embodiments of the present invention, the anode side and the cathode side of the apparatus may be interchanged.

Note that in the embodiment of FIG. 14, fuel cell 1410 extends beyond cathode plate 1420 and anode plate 1430. The embodiment of FIG. 14 therefore allows testing of only that portion of the fuel cell 1410 that is exposed to fuel and oxidant and in contact with current collectors 1425, 1435. In alternate embodiments of the present invention, the fuel cell does not extend beyond the anode and cathode plates. In such alternate embodiments, an additional cell holder or frame may be used to assure proper sealing. In the embodiment of FIG. 14, or in alternate embodiments, the shape of the fuel cell may differ from the shape of the anode and cathode plates (e.g., round fuel cell and square anode and cathode plates), or the fuel cell and electrode plates may have the same shape.

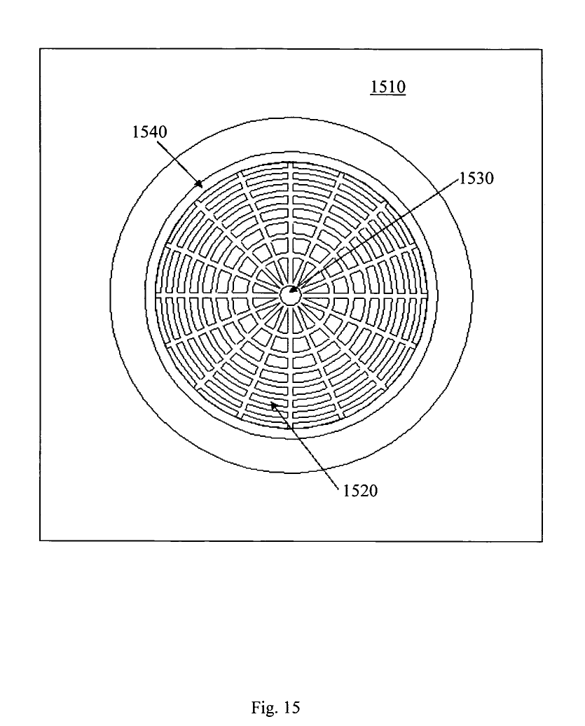

FIG. 15 is a plan view of a cell holder with attached anode plate according to an embodiment of the present invention. FIG. 15 particularly depicts the radial configuration of this embodiment. Anode plate 1520 includes a network of shallow flow channels to more evenly distribute fuel flows radially. Anode plate 1520 further includes an aperture for fuel inlet 1530 and exhaust plenum 1540 for nitrogen gas. Cell holder 1510 supports anode plate 1520.

Cell holder 1510 performs two primary functions: facilitating a nitrogen purge and providing a well-defined exhaust pathway for fuel. The nitrogen purge is generally performed only at the anode side of the fuel cell. Exhaust plenum 1540 provides a uniform dump pressure for the radial fuel flow passage. Second, cell holder 1510 defines an orifice between the body of the cell holder and the outer edge of the cell. Cell holder 1510 can be made from, by way of non-limiting example, a ceramic or metallic material. Preferred materials for direct oxidation SOFC are alumina silicate, a machinable ceramic such as MACOR, or a non-nickel containing metal such as titanium.

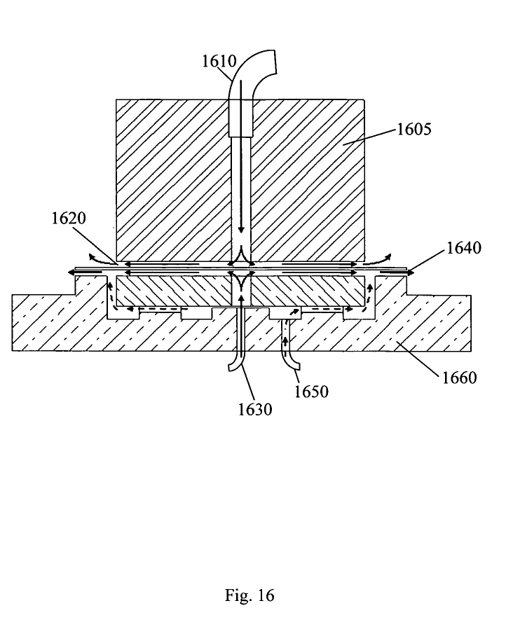

FIG. 16 is a schematic diagram of various fluid flows through an embodiment of the present invention. Oxidant inlet pipe 1610 allows oxidant to pass through cathode plate 1605, over the cathode, and out through air exhaust 1620. Fuel inlet pipe 1630 allows fuel to pass through cell holder 1660, over the anode, and out through fuel exhaust 1640. Nitrogen purge inlet pipe 1650 allows nitrogen gas to flush the anode side of the apparatus. More particularly, nitrogen gas introduced through nitrogen purge inlet creates sufficient pressure to seal the anode cavity from oxygen that may otherwise enter from outside of the test fixture. The nitrogen is then distributed to exhaust plenum 1640, where it provides a fluid barrier to prevent oxygen from outside the test fixture from entering the anode cavity. The inlet pipes may extend a substantial distance to the source of the gases. For example, if the testing apparatus is heated by way of an external furnace, the tubes would extend to supply sources outside the furnace.

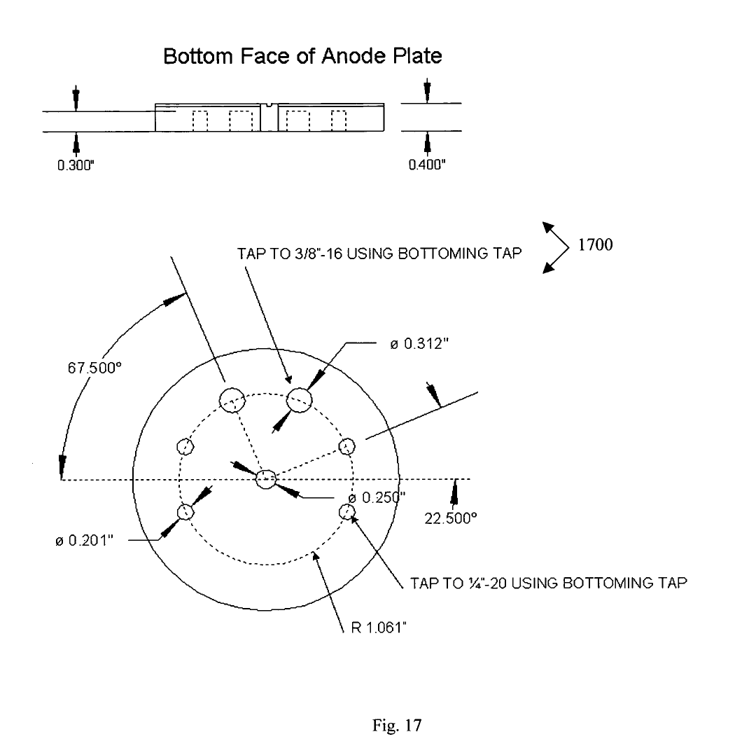

FIG. 17 depicts a bottom and side view of an anode plate according to an embodiment of the present invention. Anode plate 1700 is preferably constructed of an electrically conductive material in order to conduct current away from the cell. This material is preferably dimensionally stable at the operating temperatures of the fuel cell, but it need not be oxidation resistant since the part is kept in a reducing atmosphere. Copper, by way of non-limiting example, is a preferred material for direct oxidation SOFC because carbon deposits do not form on copper in the presence of hydrocarbons at the high operating temperatures associated with such fuel cells. Nickel, by way of non-limiting example, may be used with conventional SOFCs. Because the anode of this embodiment is not exposed to oxygen at high temperatures (it is surrounded by nitrogen and/or fuel), a metal that would normally oxidize at high temperatures may be used. Thus, nickel or copper can be used instead of titanium due to the non-oxidizing environment.

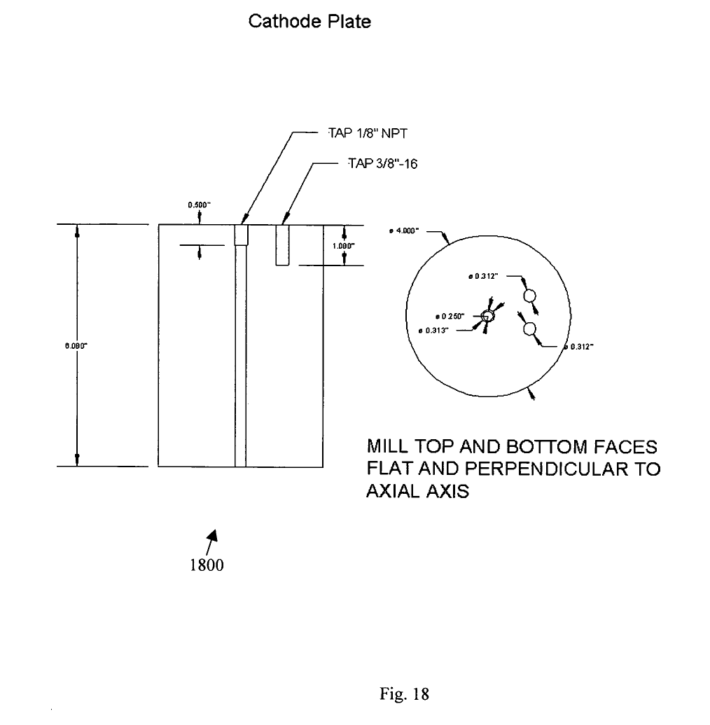

FIG. 18 is a plan view and side view of a cathode plate according to an embodiment of the present invention. The weight of cathode plate 1800 provides a downward normal force. This normal force seals the included fuel cell so that fuel does not leak from the anode side to the cathode side and so that oxidant does not leak from the cathode side to the anode side. Further, the normal force serves to mate the current collectors with their respective electrodes, thereby reducing resistance and ensuring efficient current collection. The height of the cathode plate may be changed to vary the weight depending on how much contact force is desired. Cathode plate 1800 also serves to conduct current from the cell and distribute air to the cathode side of the cell. A preferred material for cathode plate 1800 is stainless steel.

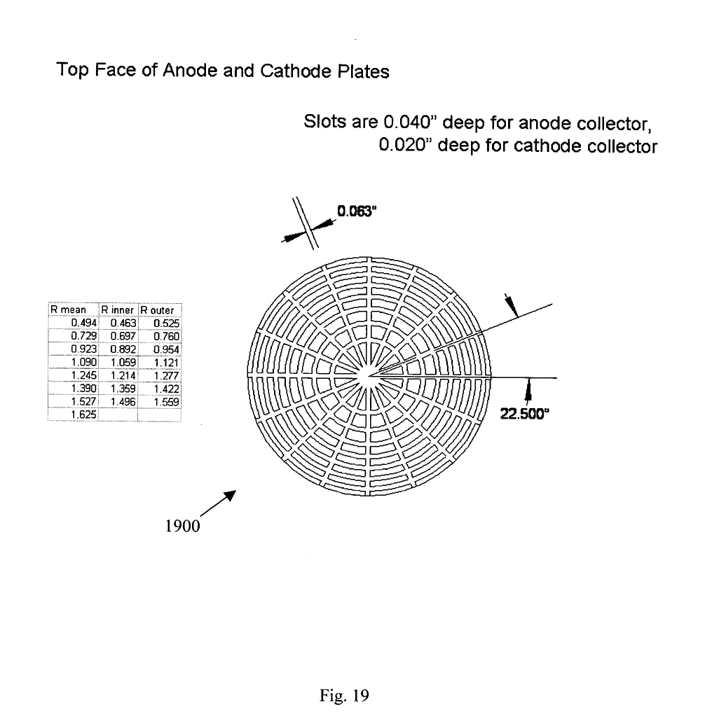

FIG. 19 is a detail of the top faces of anode and cathode plates according to an embodiment of the present invention. In this example, the anode and cathode plates include sixteen radial channels and eight circular channels. Each channel is 0.063 inches wide and 0.040 and 0.020 inches deep for the anode and cathode plates, respectively. These channels facilitate dispersal of oxidant to the cathode and fuel to the anode. The geometry of such channels may be changed according to different embodiments of the present invention to test different types and configurations of fuel cells.

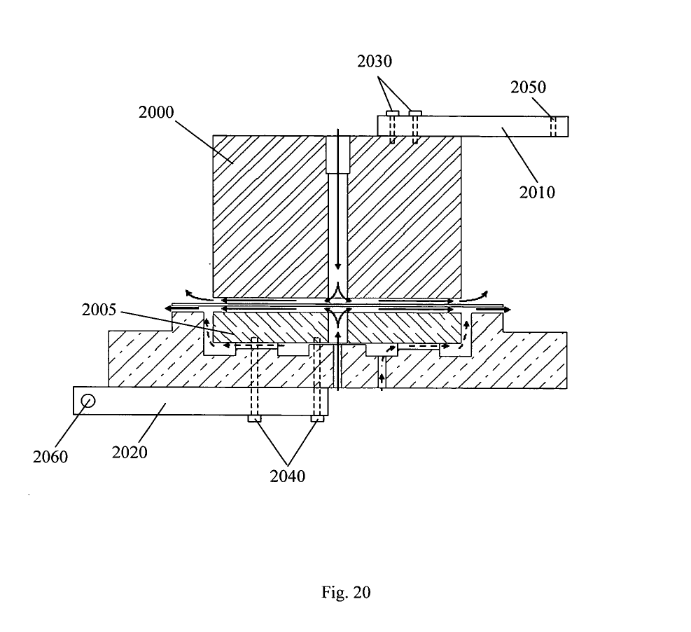

FIG. 20 is a depiction of current leads attached to a fuel cell test apparatus according to an embodiment of the present invention. Cathode current lead 2010 is secured to cathode plate 2000 by electrically-conductive bolts 2030. Cathode current lead 2000 further includes a portion, by way of non-limiting example, threading 2050, for the attachment of wiring. Anode current lead 2020 is attached to anode 2005 by electrically-conductive bolts 2040. Anode current lead also includes a portion where wiring may be attached, such as, by way of non-limiting example, threading 2060. The locations of attachment of the current leads depicted in FIG. 20 are not meant to be limiting; other attachment locations are also contemplated.

Embodiments of the present invention may include any, or a combination, of the following modifications to the embodiments disclosed herein. End plates and/or interconnect plates may be constructed from, by way of non-limiting example, titanium, a ferritic stainless steel, or some other low expansion metal having desirable properties for oxidation, creep strength, low chromium volatility, etc. A ceramic, such as zirconia or alumina, may be used to form some or all of the structural parts discussed herein. A machinable ceramic such as Macor may be used in such capacity. Ceramics generally have the advantage of being more durable under high temperature operation. In embodiments of the present invention, the inner seal may be constructed from, by way of non-limiting example, ceramic paper, rigid glass, glass ceramic, full ceramic, or metal braze. The outer seal may be constructed of, by way of non-limiting example, ceramic paper, mica, glass, glass ceramic, or rigid ceramic.

Further modifications or features of certain embodiments of the present invention may include, but are not limited to, one or more of the following. Cell geometries include, by way of non-limiting example, square, rectangular, circular and elliptical. (Embodiments of the present invention may be designed and machined to fit almost any size and shape cell.) Embodiments of the present invention may be configured to test a single cell, or several cells at once, e.g., in a stack configuration. Embodiments of the present invention may incorporate heaters into features such as brace plates. The addition of heaters obviates the need to test inside a furnace. Embodiments of the present invention may provide a compressive load to the cell using, by way of non-limiting example, bolts, hydraulic or pneumatic means external to the heated section, or gravity. (Embodiments of the present invention may rely on such compressive force to obviate the need for seals between anode and cathode sides of the cell or cells undergoing electrochemical testing.) Embodiments of the present invention may include component parts constructed of, by way of non-limiting example, stainless steel, titanium, alumina silicate, MACOR, zirconia and alumina, copper, nickel, and superalloys such as Inconel, Hastelloy, and Haynes 230. It is often desirable to use more than one material for constructing embodiments of the present invention. For the anode-side purge, gases other than nitrogen may be used. Such gases include, by way of non-limiting example, inert gases such as argon and neon. The invention is not limited to solid oxide fuel cells. Indeed, testing of any solid-membrane fuel cell (or similarly-configured fuel cell) is contemplated. The exemplary further modifications detailed above are in no way limiting to the invention.

1. An apparatus for repeated electrochemical testing of a plurality of fuel cells, the apparatus comprising a housing configured to contain a first fuel cell during operation of the first fuel cell, the housing comprising at least a first electrically conductive member configured to electrically contact an anode of a fuel cell being tested and a second electrically conductive member configured to electrically contact a cathode of a fuel cell being tested, the housing being configured to substantially seal the first fuel cell during testing, wherein the housing is configured to allow removal of the first fuel cell without substantial damage to the first fuel cell and subsequently contain a second fuel cell during operation of the second fuel cell.

2. The apparatus of claim 1 wherein the first fuel cell is selected from the group consisting of: a solid oxide fuel cell, a proton exchange fuel cell, and a direct methanol fuel cell.

3. The apparatus of claim 1 wherein the first fuel cell is one of a plurality of electrically connected fuel cells.

4. The apparatus of claim 1 wherein the housing comprises a material selected from the group consisting of: titanium and steel.

5. The apparatus of claim 1 further comprising a seal constructed of a material selected from the group consisting of: ceramic, ceramic paper, silica, ceramic paste, glass ceramic, mica, glass, and putty.

6. The apparatus of claim 1 further comprising at least one pressure gauge configured to measure at least one of: a pressure in a fuel line, a pressure in an oxidant line, and a difference in pressure between a fuel line and an oxidant line.

7. The apparatus of claim 1 further configured to test a fuel reforming catalyst.

8. The apparatus of claim 1 wherein the housing comprises a ceramic.

9. The apparatus of claim 1 wherein the first fuel cell has a shape selected from the group consisting of: square, rectangle, circle, and ellipse.

10. The apparatus of claim 1 further comprising a source of heat.

11. The apparatus of claim 1 further comprising a first plate and second plate, the first plate and the second plate containing the first fuel cell therebetween, and at least two bolts configured to apply a compressive force to the first fuel cell.

12. The apparatus of claim 1, wherein no gasket is present between the anode and the cathode.

13. The apparatus of claim 1, wherein the housing being configured to substantially seal the first fuel cell during testing comprises the housing being configured to substantially prevent oxidant from contacting an anode and fuel from contacting a cathode.

14. A method of electrochemically testing a plurality of fuel cells, the method comprising:
containing a first fuel cell in a housing configured to allow for operation of the first fuel cell;
substantially sealing the first fuel cell;
operating the first fuel cell;
measuring at least one parameter of the first fuel cell during the step of operating the first fuel cell;
removing the first fuel cell from the housing, whereby the first fuel cell is substantially undamaged by the step of removing;
containing a second fuel cell in the housing, whereby the second fuel cell is substantially sealed;
operating the second fuel cell; and
measuring at least one parameter of the second fuel cell during the step of operating the second fuel cell.

15. The method of claim 14 wherein the first fuel cell is selected from the group consisting of: a solid oxide fuel cell, a proton exchange fuel cell, and a direct methanol fuel cell.

16. The method of claim 14 wherein the first fuel cell is one of a plurality of connected fuel cells.

17. The method of claim 14 further comprising measuring at least one parameter relating to a fuel reforming catalyst associated with the first fuel cell.

18. The method of claim 14 further comprising sealing the fuel cell using a material selected from the group consisting of: ceramic, ceramic paper, silica, ceramic paste, glass ceramic, mica, glass, and putty.

19. The method of claim 14 further comprising measuring at least one of: a pressure in a fuel line, a pressure in an oxidant line, and a difference in pressure between a fuel line and an oxidant line.

20. The method of claim 14 further comprising heating the first fuel cell.

21. The method of claim 14 further comprising applying a compressive force to the first fuel cell.

22. The method of claim 21 wherein the compressive force is supplied by a weight.

23. The method of claim 14, wherein the step of substantially sealing does not require using a gasket.

24. The method of claim 14, wherein the step of substantially sealing comprises substantially preventing oxidant from contacting an anode and fuel from contacting a cathode.

25. An apparatus for repeated electrochemical testing of a plurality of fuel cells, the apparatus comprising:
means for electrically connecting with a first electrode of a fuel cell;
means for electrically connecting with a second electrode of a fuel cell;
means for providing an oxidant to an anode of a fuel cell;
means for providing fuel to an anode of a fuel cell; and
means for keeping the fuel and oxidant separate;
wherein the means for electrically connecting with a first electrode, the means for electrically connecting with a second electrode, the means for providing an oxidant, and the means for providing fuel are configured to allow operation of a first fuel cell, removal of the first fuel cell without substantial damage to the first fuel cell, and subsequent operation of a second fuel cell.

26. The apparatus of claim 25, further comprising means for heating a fuel cell.

27. The apparatus of claim 25, further comprising means for applying pressure to a fuel cell.

28. The apparatus of claim 25, further comprising means for substantially sealing a fuel cell.
